(19) United States
(12) Patent Application Publication
(10) Pub. No.: US 2025/0344676 A1
(43) Pub. Date: Nov. 13, 2025

(54) BEEHIVES AND BEEHIVE STANDS

(71) Applicant: Josee Bourget, Hope Mills, NC (US)

(72) Inventor: Josee Bourget, Hope Mills, NC (US)

(21) Appl. No.: 19/276,928

(22) Filed: Jul. 22, 2025

Related U.S. Application Data
(63) Continuation of application No. 18/586,103, filed on Feb. 23, 2024, now Pat. No. 12,364,253.
(60) Provisional application No. 63/447,856, filed on Feb. 23, 2023.

(51) Int. Cl. A01K 47/06

(52) U.S. Cl. CPC A01K 47/06

(57) ABSTRACT

Beehives and beehive stand are provided herein. A beehive stand for use as a base of a beehive can include a stand body having a first side wall and a second side wall and a top portion having an opening therethrough. Each of the first and second side walls include an inner wall face with a drawer slide groove and a bottom board slide groove in the respective inner wall face of the respective first and second side wall. The inner wall faces of first and second side walls face each other such that the drawer slide grooves in the respective inner wall faces align and the bottom board slide grooves in the respective inner wall faces align. The beehive stand includes a drawer having a drawer front secured to a litter tray. The litter tray having side portions that are configured to slide along the drawer slide grooves in the respective first and second side walls to allow the drawer to be inserted and held within the stand body and removed from the stand body. The beehive stand includes a bottom board having side portions that are configured to slide along the bottom board slide grooves in the respective first and second side walls to allow the bottom board to be inserted and held within the stand body and removed from the stand body. A screen is secured to the top portion of the stand body covering the opening in the top portion, the screen residing above the litter tray of the drawer when the drawer is inserted in the stand body along the drawer slide grooves of the first and second side walls.

### RELATED APPLICATIONS

The presently disclosed subject matter is a continuation of and claims benefit to U.S. patent application Ser. No. 18/586,103, filed Feb. 23, 2024, which claims the benefit of U.S. Provisional Patent Application Ser. No. 63/447,856, filed Feb. 23, 2023, the disclosure of these applications are incorporated herein by reference in their entireties.

### TECHNICAL FIELD

The present subject matter relates to beehives, beehive stands and related methods. In particular, the present subject matter relates to Langstroth beehives and hive stands that form the base of such beehives and methods related to such beehives and hive stands.

### BACKGROUND

Beehives provide a home for bees that make it easy for beekeepers to have access for removal of honeycomb and honey from the beehive. Traditionally, the beehives, or hives, have a base, or bottom board, that is solid. These solid bottom boards are most used by beekeepers. The bees constantly work at keeping their hive clean of foreign materials and free of pests, but it is necessary for beekeepers to make sure that the bottom board stays debris free as much as possible. This is to help prevent disease and pest invasion. For example, hive beetles tend to drop to the bottom as bees chase them away but climb back up into the nest to lay eggs and sour the honey crop. Their larvae also feed from the nest litter and become adult beetles that promote infestation. As tiny as they are, the Varroa mites, which carry viruses and are the number one enemy of honeybees, can and do climb back up as well.

An alternative to the solid bottom board is the screened bottom board, which lets the beetles, mites, and other nest waste fall to the ground. However, it does not offer any insulation from winter conditions. Ambient air temperature is of great concern to honeybee colonies. Bees strive to keep the center of the cluster around 95 F year round, while the mantle averages 48 F in the winter. Condensation and moisture cause bees, and subsequently the colony, to chill and die. The chilling effect prevents the bees from moving about to feed and maintain proper body temperature, which in turn inhibits them from using their muscles to warm up the cluster as needed. That means beekeepers have to swap out bottom board if they wish to protect the bees from the cold draft and humidity coming from the ground that contribute to the chilling effect. This is why most beekeepers use the traditional solid bottom permanently. Plans to move further north made me ponder over the screened bottom designs.

The open screened bottom issue mentioned above is somewhat mitigated by adding slides under the screened bottom to insert a piece of corrugated plastic board, which is called an IPM board, with an optional stick-on grid. It slides in right below the wire mesh but offers no means of preventing the pests from getting back up into the hive other than a bit of distance. In addition, the debris gets caught and dragged across the wood ware right above, when pulling the board out. That defeats the efforts of noting what type of debris fell onto the IPM board, which is helpful to beekeepers. The stick on paper gets dirty and impossible to clean without eventually replacing the entire IPM board. This setup is also open to critters since it is not fully enclosed; not to mention that this would not provide adequate insulation for winter.

As such, a need exists for a beehive and hive stand that make removal and monitoring waste easier, while at the same time reduce moisture and condensation build up to allow a beekeeper to better monitor and prolong the life of their bees within a beehive.

### SUMMARY

The present subject matter relates to beehives, beehive stands and related methods. In particular, the present subject matter relates to Langstroth beehives and hive stands that form the base of such beehives. Methods related to the assembly and use of the beehives and hive stands disclosed herein are also provided.

Thus, it is an object of the presently disclosed subject matter to provide beehives and beehive stands as well as methods related thereto. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a perspective view of an embodiment of a Langstroth bee hive according to the present subject matter;

FIG. 2 illustrates a side perspective view of an embodiment of a hive stand according to the present subject matter with an embodiment of a drawer partially pulled outward from the hive stand;

FIG. 3 illustrates a side perspective view of the embodiment of the hive stand according to FIG. 2 with the drawer removed and an embodiment of a bottom board partially pulled out from the hive stand;

FIG. 4 illustrates a partial side perspective view of an embodiment of the hive stand according to FIG. 2 with the drawer in a closed position according to the present subject matter;

FIG. 5 illustrates a partial side perspective view of the embodiment of the hive stand according to FIG. 2 with the drawer in a partial open position according to the present subject matter;

FIG. 6 illustrates a partial side perspective view of the embodiment of the hive stand according to FIG. 2 with the drawer removed and the bottom board being partially pulled out, or partially removed, according to the present subject matter;

FIG. 7 illustrates a bottom perspective view of the embodiment of the hive stand according to FIG. 2 with the drawer and the bottom board removed according to the present subject matter;

FIG. 8 illustrates a front side plan view of the embodiment of the hive stand according to FIG. 2 and a rear side plan view of the embodiment of the hive stand according to FIG. 2;

FIG. 9 illustrates a side vertical cross-sectional view of the embodiment of the hive stand according to FIG. 2

FIG. 10 illustrates a top plan view of the embodiment of the hive stand according to FIG. 2;

FIG. 11 illustrates a partial top perspective view of the embodiment of the hive stand according to FIG. 2 showing embodiments of a landing board, a front cross member and a side wall of the hive stand according to the present subject matter; and

FIG. 12 illustrates a top plan view of and embodiment of a drawer according to the present subject matter that has been in use in an embodiment of the hive stand according to FIG. 2.

Repeat use of reference characters in the present specification and drawings is intended to represent the seam or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, top, bottom, upper lower, vertical, horizontal, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer, or section. Thus, a first feature, element, component, region, layer, or section discussed below could be termed a second feature, element, component, region, layer, or section without departing from the teachings of the disclosure herein. Additionally, such terms as right, left, front, back, top, bottom, upper lower, vertical, horizontal, etc. are simply describing the relative position or movement of the features or elements to each other and do not necessarily mean an absolute position or movement since the relative position or movement depends upon the orientation of the device to the viewer and/or user.

Similarly, when a feature or element is being described in the present disclosure as “on” or “over” another feature or element, it is to be understood that the features or elements can either be directly contacting each other or have another feature or element between them, unless expressly stated to the contrary. As above, these terms are simply describing the relative position of the features or elements to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5.

As used herein, the term a “plurality” means two or more.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified. As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to +10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

The present subject matter relates to beehives, beehive stands and related methods. In particular, the present subject matter relates to Langstroth beehives and hive stands that form the base of such beehives. Methods related to the assembly and use of the beehives and hive stands disclosed herein are also provided.

Thus, the present disclosure relates to beehives and beehive stand for use as a base of a beehive that provides a more compact construction with beehive stand being configured to several functions that were performed by multiple separate and independent section within traditional beehives. The beehive stand can comprise a stand body comprising a first side wall and a second side wall as well as a top portion. The top portion can have an opening therethrough. Each of the first and second side walls can comprise an inner wall face with a drawer slide groove and a bottom board slide groove in the respective inner wall face of the respective first and second side wall. The inner wall faces of first and second side walls face each other such that the drawer slide grooves in the respective inner wall faces align and the bottom board slide grooves in the respective inner wall faces align. The beehive stand also can comprise a drawer comprising a drawer front secured to a litter tray. The litter tray can have side portions that are configured to slide along the drawer slide grooves in the respective first and second side walls to allow the drawer to be inserted and held within the stand body and removed from the stand body as needed or desired. Additionally, the beehive stand can comprise a bottom board having side portions that are configured to slide along the bottom board slide grooves in the respective first and second side walls of the stand body to allow the bottom board to be inserted and held within the stand body and removed from the stand body as needed or desired. Further, the beehive stand also can comprise a screen secured on a top portion of the stand body covering the opening in the top portion. The screen resides over the opening in the top portion above the litter tray of the drawer when the drawer is inserted in the stand body along the drawer slide grooves of the first and second side walls.

Among other features, some embodiments of the stand body can comprise a landing board on a front end on the stand body. The landing board can be sloped to provide a landing area for bees. Additionally, some embodiments of the beehive stand can comprise a rain guard extending from the stand body above the where the drawer is inserted in the stand body. The rain guard can have a slope surface extending outward from the rear top portion such that the rain guard overhangs the drawer front when the drawer is in a closed position to aid in preventing rain from entering the beehive stand around the drawer. These and other features of the beehives and beehive stands disclosed herein are described in more detail below in reference to the Figures.

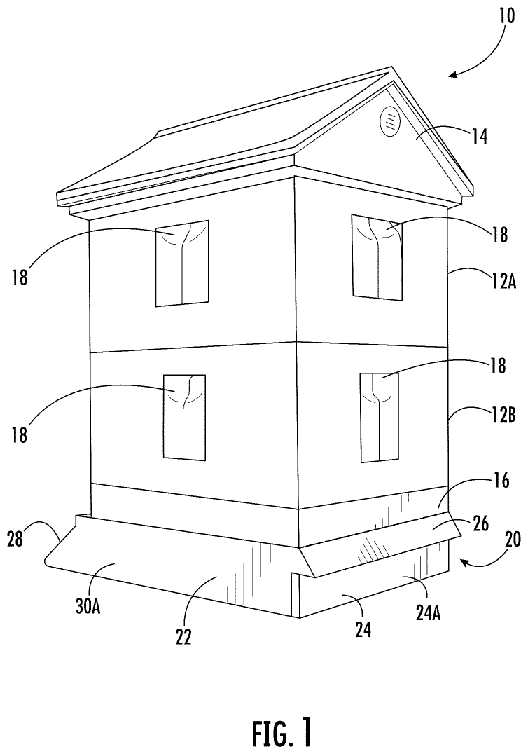

Referring to FIG. 1, an embodiment of beehive, generally designated 10, is provided. The beehive 10 can comprise a variety of different sections and components including but not limited to one or more brood chambers, one or more honey supers, frames for inclusion in the brood chambers and honey supers, a queen excluder, a beehive stand (i.e., hive stand), slatted rack between the hive stand and the one or more brood chambers, an inner cover and an outer cover that reside atop the hive covering the top of the one or more honey supers and brood chambers, and entrance reducer that can be placed at the entrance of the beehive adjacent a landing board of the hive stand that can be use to reduce the size of the hive entrance when needed, for example during cold weather.

In the embodiment shown in FIG. 1, the beehive 10 comprises a first brood chamber 12A residing atop second brood chamber 12B. A cover 14 can reside over the first, or top brood chamber 12A that closes the top of the beehive. The cover 14 can comprise an inner cover and an outer cover. The outer cover of the cover 14 can have a sloped A-frame roof as shown or a flat roof, or a flat sloped roof not shown. The A-frames can be useful in diverting rain from a front side and rear side of the beehive 10. The second brood chamber 12B can reside atop a slatted rack 16 used to help with ventilation and hive congestion within the beehive 10. The slatted rack 16 can give the bees more room between an entrance and the second brood chamber 12B. The brood chambers 12A, 12B can also include ventilation vents 18 on one or more sides of the chambers 12A, 12B to facilitate proper ventilation within the beehive 10. The slatted rack in the beehive 10 in FIG. 1 resides atop a beehive stand generally 20.

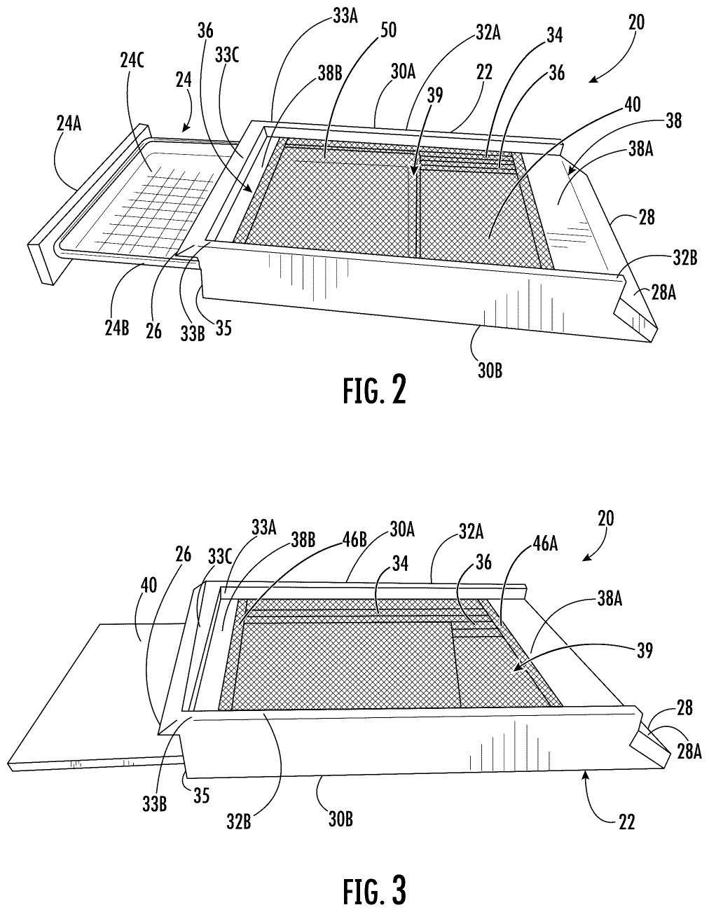

The beehive stand 20 can comprise a stand body 22 that can include a landing board 28 on a front side of the beehive 10 and a drawer 24 having a drawer front 24A on the rear side of the beehive 10. A rain guard 26 can extend outward from the rear side of the stand body 22 overhanging the drawer 24 and drawer front 24A when the drawer 24 is in a closed position. Since the drawer 24 will be opened and closed to help clean the beehive 10 as explained further below, propolis provided by the worker bees cannot be used by the bees to seal the cervices around the drawer 24. The rain guard 26 can be used to divert the rain from around the drawer to prevent rain from infiltrating the beehive 10 around the crevices between the stand body 22 and the drawer 24. Additionally, the beehive stand 20 can comprise a bottom board 40 (see FIGS. 2 and 3) that can reside within the stand body 22 below the drawer 24 as described further below.

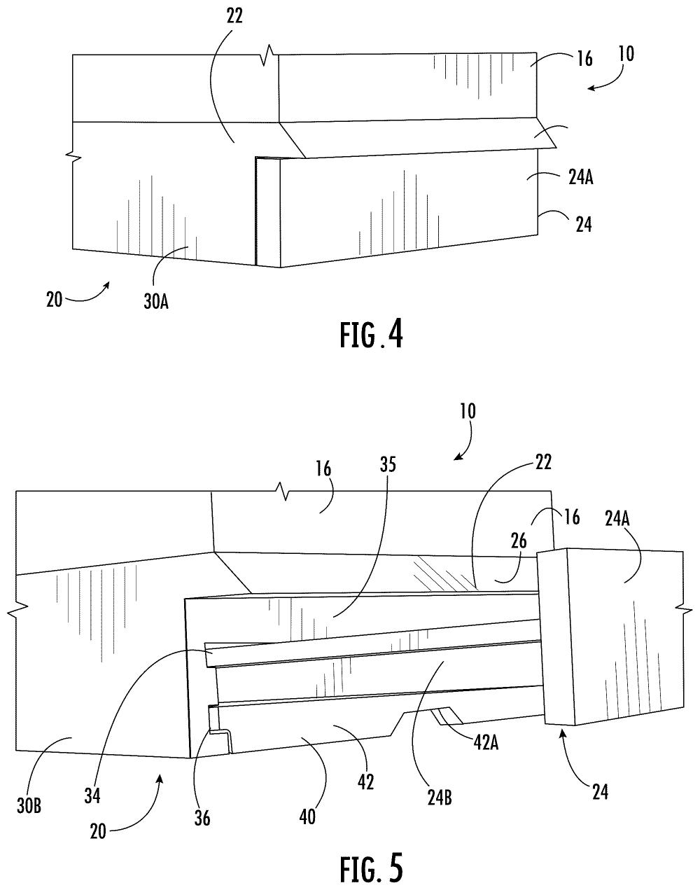

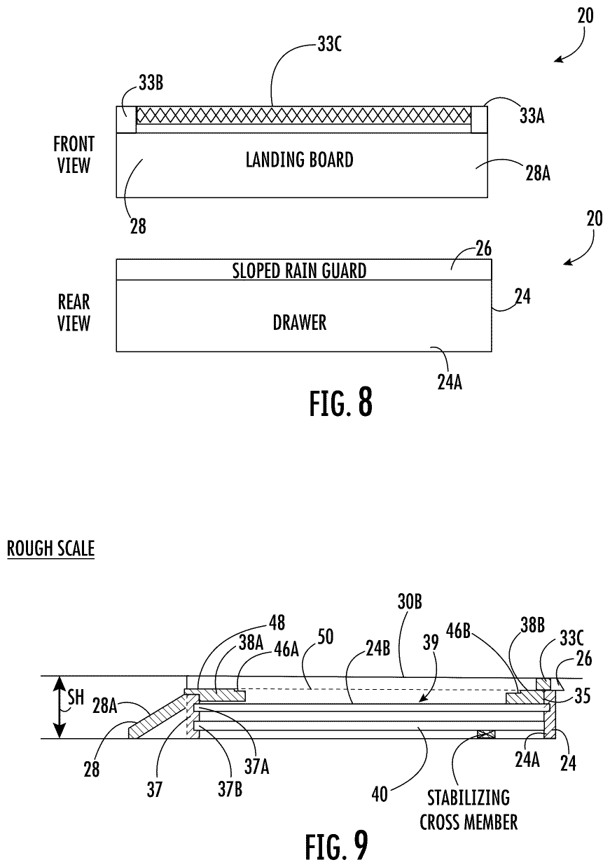

Referring to FIGS. 2-10, the stand body 22 can comprise a first side wall 30A and a second side wall 30B. The first and second side walls 30A, 30B Each of the first and second side walls 30A and 30B can respectively comprise an inner wall face with a drawer slide groove 34 and a bottom board slide groove 36 in the respective inner wall face of the respective first and second side wall 30A and 30B. The inner wall faces of first and second side walls 30A, 30B face each other such that the drawer slide grooves 34 in the respective inner wall faces of the first and second side walls 30A, 30B align with each other and the bottom board slide grooves 36 in the respective inner wall faces of the first and second side walls 30A, 30B align each other. The drawer slide grooves 34 and the bottom board slide grooves 36 of the first and second side walls 30A, 30B fallow for insertion and removal of the drawer 24A and bottom board 40 from the stand body 22 and the hive stand 20.

The drawer 24 can further comprise a litter tray 24B secured to the drawer front 24A. The litter tray 24B of the drawer 24 can comprises a bottom portion having a flat surface with front and rear end walls and two side walls that extend between the front and rear end walls. In some embodiments, the front and rear end walls of the litter tray 24B can be about parallel to each other and the side walls can extend about parallel to each other. The front and rear end walls and the side walls of the litter tray 24B of the drawer 24 can extend upward from the flat surface of the bottom portion. The litter tray 24B with its flat surface on the bottom portion is used to catch waste that falls out of the brood chamber 12A, 12b and other sections of the beehive 10. When the drawer 24 is in a closed position in some embodiments as shown, the drawer front 24A can extend to the bottom of the stand body 22 and can cover the bottom board slide groves in the first and second side walls 30A, 30B such that the drawer 24 must be removed to remove the bottom board 40. Further, in some embodiments, the drawer front 24A is reside against the rear end 35 of the stand body 22 when in a closed position such that the drawer front 24A aligns and is about flush with the rest of the rear of walls of the sections of the beehive 10.

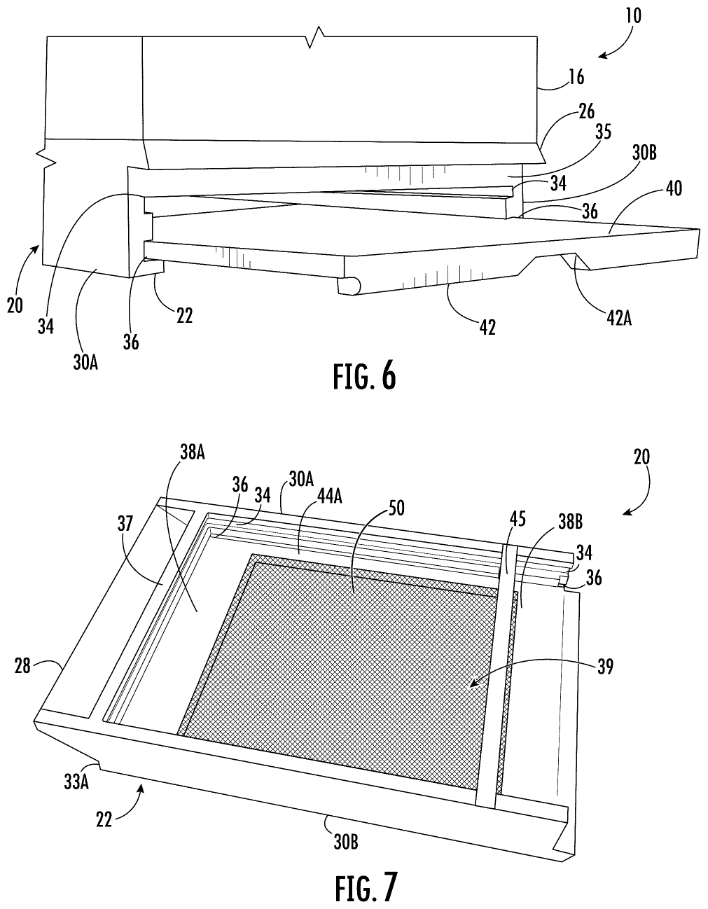

The litter tray 24B can have side portions that are configured to slide along the drawer slide grooves 34 in the respective first and second side walls 30A, 30B to allow the drawer 24 to be inserted and held within the stand body 22 and, when needed or desired, removed from the stand body 22. For example, the two side walls of the litter tray 24B can have peripheral edges that are configured to slide within the drawer slide grooves 34 in the respective first and second side walls 30A, 30B. Similarly, the bottom board 40 of the beehive hive stand 20 can have side portions that are configured to slide along the bottom board slide grooves 30 in the respective first and second side walls 30A, 30B of the stand body 22 to allow the bottom board 40 to be inserted and held within the stand body 22. When need, the bottom board 40 can then be removed from the stand body 22 as shown in the process of removal in FIGS. 3 and 6.

The stand body 22 can also comprise a top portion, generally designated 38. The top portion 38 can have an opening 39 therethrough. The beehive stand 20 can also comprise a screen 50 that can be secured on a top portion 38 of the stand body 22 covering the opening 39 in the top portion 38. The screen can reside over the opening 39 in the top portion 38 above the litter tray 24B of the drawer 24 when the drawer 24 is inserted in the stand body 22 along the drawer slide grooves 34 of the first and second side walls 30A, 30B.

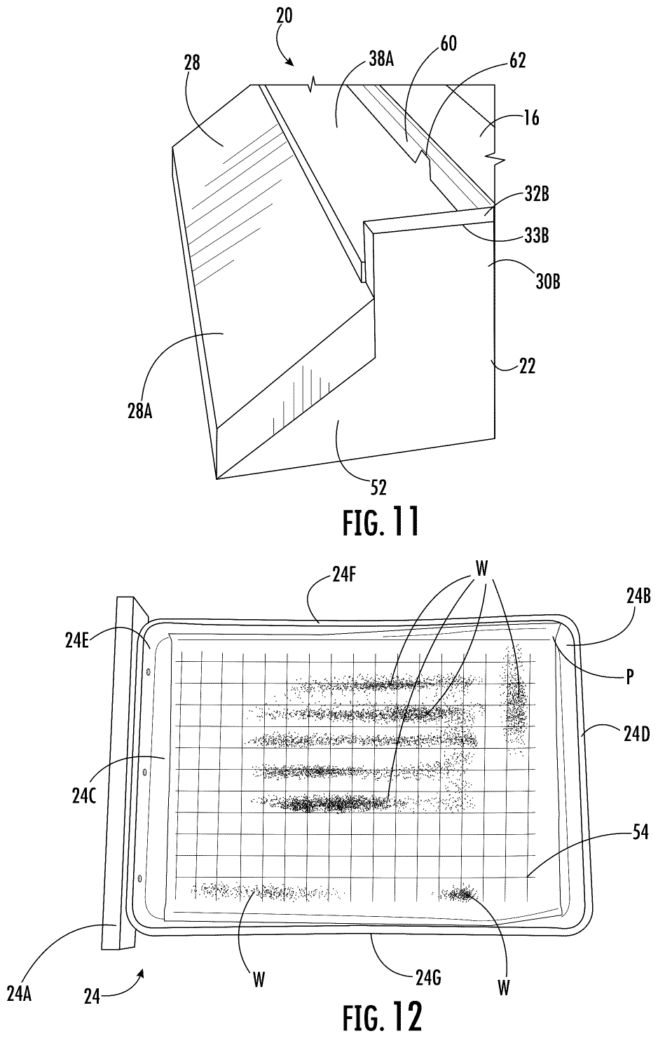

For example, in some embodiments of the hive stand 20 as shown in FIGS. 2, 3, 7, 9, and 10, the top portion 38 can comprise a front top portion 38A and a rear top portion 38B with the opening 39 between the front top portion 38A and the rear top portion 38B of the stand body 22. The front top portion 38A can extend between the first and second side walls 30A, 30B. Additionally, the front top portion 38A can extend above the landing board 28 and partially inward toward the rear end 35 of the stand body 22. The front top portion 38A of the stand body 22 can comprise a front end, a rear end, a top side, and a bottom side. Similarly, the rear top portion 38B can extend between the side walls 30A, 30B at the rear end 35 of stand body 22 and the rear top portion 38B of the stand body 22 can comprise a front end, a rear end, a top side, and a bottom side. As shown in FIG. 9, the front top portion 38A has a landing board channel 48 in the bottom side of the front end of the front top portion 38A for receiving a top portion of the landing board 28 underneath the front top portion 38A. In some embodiments as shown in FIG. 9, the stand body 22 comprises a front end wall 37 that extends downward behind the landing board 28 under the landing board channel 48 in the front top portion 38A of the stand body 22. The front end wall 37 can have an inner face with a drawer channel 37A into which a front portion of the litter tray 24B of the drawer 24 can be inserted when the drawer 24 is in a closed position. Similarly, the inner face of the front end wall 37 can have a bottom board channel 37B in which a front portion of the bottom board 40 can be inserted when the bottom board 40 is in an installed position. The landing board 28 can reside against sloped ramped portions 52 that extend out from the first and second side walls 30A, 30B. The landing board 28 can reside against sloped ramped portions 52 that extend out from the first and second side walls 30A, 30B as shown in FIG. 11. The landing board channel 48 provides for a smooth transition between the surface 28A of the landing board 28 and the front top portion 38A of the hive stand 20 that can be about flush to reduce potential infiltration of moisture. Thus, the depth of the landing board channel 48 can vary depending on the presence and thickness of the front end wall 37 as long as the end of the front top portion 38A extends over the top of the landing board 28. For example, in some embodiments, the landing board channel can have a depth that allows for ¼ inch over joint.

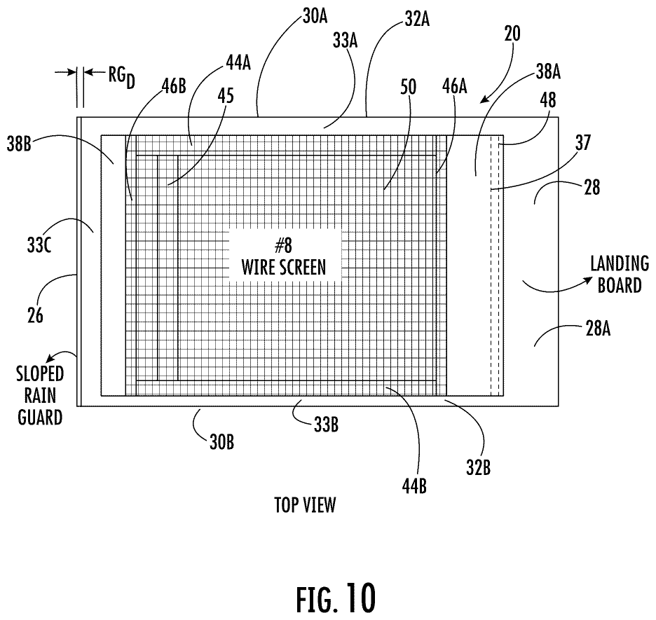

When the screen 50 is installed, the screen 50 allows the beetles, mites, and other nest waste fall from the brood chambers 12A, 12B to the litter tray 24B of the drawer 24. As shown in FIG. 12, the flat surface of the bottom portion of the litter tray 24B comprises grid lines 54 thereon for visual referencing and collection of metrics related to waste that falls from chambers of the beehive. To secure the screen 50 to the stand body 22, the front top portion 38A can have a screen channel 46A in the top side of the rear end of the front top portion 38A. Similarly, the rear top portion 38B can have a screen channels 46A, 46B in the respective front and rear top portions 38A, 38B providing ledges on which the screen can be secured. The depth of the screen channels 46A, 46B in the respective front and rear top portions 38A, 38B can be such that the screen 50, when installed on the stand body 22, is about flush with the top sides of the front and rear top portions 38A, 38B. So, the depth of the screen channels 46A, 46B can depend on the thickness of the screen 50 that is to be used. For example, in some embodiments, the depth of the screen channels 46A, 46B in the respective front and rear top portions 38A, 38B can be about ⅛ inch. In some embodiments, the ledge formed by the screen channels 46A, 46B in the respective front and rear top portions 38A, 38B can be about ½ inch. To further help secure the screen 50, screen rails 44 can be secured to the inner wall faces of first and second side walls 30A, 30B as shown in FIGS. 7 and 10. The screen rails 44 can have a top surface that aligns with the screen channels 46A, 46B in the front and rear top portions 38A, 38B of the stand body 22 such that the top surface of the screen rails 44 are flush with the ledge formed by the screen channels 46A, 46B. The screen rails 44 and the ledges of the screen channels 46A, 46B provide surfaces to secure the screen 50 adjacent the first and second side walls and the top portion 38 of the stand body 22.

In some embodiments, the rain guard 26 that extends from stand body 22 can extend from the rear top portion 38B of the stand body 22. As stated above, the rain guard can have a slope surface extending outward from the rear top portion 38B such that the rain guard 26 overhangs the drawer front 24A to aid in preventing rain from entering the beehive stand 20 around the drawer 24. Further, as shown in FIGS. 2, 3, 8 and 10, a rear cross member 33C can be secured to the top side of the rear top portion 38B of the stand body 22 that extends between the upper portion of the side walls 30A, 30B of the stand body 22. The rear cross member 33 and the upper portions 32A, 32B of the side walls 30A, 30B of the stand body 22 can form supports 33A, 33B that with cross member 33C provide structure on which the lower section of the beehive, such as the slat rack 16 or a lower brood chamber 12B, for example, can reside when the beehive is formed. In some embodiments, the supports 33A, 33B can be separate structure secured to the top portion of the side walls 30A, 30B of the stand body instead of being an integral part of the side walls 30A, 30B as shown in the figures. In some embodiments, the supports 33A, 33B, 33C, can provide enough space between the surface of the front top portion 38A of the stand body and the adjacent section of the beehive 10, such at the slat rack 16 as shown in FIG. 1, to form an entrance for the beehive 10 adjacent the landing board 28. The entrance can include an entrance reducer 60 installed therein when needed to limit access to the beehive 10 and to increase heat retention within the beehive 10. In some embodiments, rain guard 26 can be secured to the cross member 33C. In some embodiments, the rain guard 26 and the cross member 33C can be a single unitary structure. While shown as a part of the These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only, and is not intended to limit the present subject matter.

What is claimed is:

1. A beehive stand for use as a base of a beehive, the beehive stand comprising:
a stand body comprising a first side wall and a second side wall and a top portion having an opening therethrough;
a drawer comprising a drawer front secured to a litter tray, the drawer removably insertable into the stand body with h litter tray residing between the respective first and second side walls; and
a bottom board removably insertable into the stand body between the respective first and second side walls below the drawer.

2. The beehive stand according to claim 1, wherein the stand body comprises a front end wall extending between the first and second side walls.

3. The beehive stand according to claim 2, wherein the first and second side walls each comprises an inner wall face with a drawer slide groove and a bottom board slide groove in the respective inner wall face of the respective first and second side wall for receiving the drawer and the bottom board, respectively, and the front end wall having an inner face with a drawer channel and a bottom board channel therein for receiving the respective drawer and the bottom board.

4. The beehive stand according to claim 1, wherein the stand body further comprises a screen secured to the top portion of the stand body covering the opening in the top portion, the screen residing above the litter tray of the drawer when the drawer is inserted in the stand body.

5. The beehive stand according to claim 4, wherein the top portion of the stand body comprises a front top portion that extends between the first and second side walls, the front top portion of the stand body comprises a front end and a rear end and a top side and a bottom side.

6. The beehive stand according to claim 5, wherein the top portion of the stand body further comprises a rear top portion that extends between the first and second side walls at the rear end of stand body, the rear top portion of the stand body comprises a front end and a rear end and a top side and a bottom side.

7. The beehive stand according to claim 6, wherein the rear top portion has a screen channel in the top side of the front end of the rear top portion and the front top portion has a screen channel in the top side of the rear end of the front top portion, the screen channels in the front and rear top portions providing ledges on which the screen can be secured.

8. The beehive stand according to claim 7, further comprising screen rails secured to the first and second side walls, the screen rails having a top surface that aligns with the screen channels in the front and rear top portions of the stand body to secure the screen adjacent the first and second side walls.

9. The beehive stand according to claim 1, wherein the litter tray of the drawer comprises a bottom portion having a flat surface with front and rear end walls and side walls extending upward from the flat surface of the bottom portion.

10. The beehive stand according to claim 9, wherein the flat surface of the bottom portion of the litter tray comprises grid lines thereon for visual referencing and collection of metrics related to waste that falls from chambers of the beehive.

11. A beehive comprising:
a beehive stand comprising:
a stand body comprising a first side wall and a second side wall and a top portion having an opening therethrough;
a drawer comprising a drawer front secured to a litter tray, the drawer removably insertable into the stand body with h litter tray residing between the respective first and second side walls; and
a bottom board removably insertable into the stand body between the respective first and second side walls below the drawer;
one or more brood chambers positioned above the beehive stand; and
a cover that resides above the one or more brood chambers.

12. The beehive according to claim 11, wherein the stand body comprises a front end wall extending between the first and second side walls.

13. The beehive according to claim 12, wherein the first and second side walls each comprises an inner wall face with a drawer slide groove and a bottom board slide groove in the respective inner wall face of the respective first and second side wall for receiving the drawer and the bottom board, respectively, and the front end wall having an inner face with a drawer channel and a bottom board channel therein for receiving the respective drawer and the bottom board.

14. The beehive according to claim 11, wherein the stand body further comprises a screen secured to the top portion of the stand body covering the opening in the top portion, the screen residing above the litter tray of the drawer when the drawer is inserted in the stand body.

15. The beehive according to claim 14, wherein the top portion of the stand body comprises a front top portion that extends between the first and second side walls, the front top portion of the stand body comprises a front end and a rear end and a top side and a bottom side.

16. The beehive according to claim 15, wherein the top portion of the stand body further comprises a rear top portion that extends between the first and second side walls at the rear end of stand body, the rear top portion of the stand body comprises a front end and a rear end and a top side and a bottom side.

17. The beehive according to claim 16, wherein the rear top portion has a screen channel in the top side of the front end of the rear top portion and the front top portion has a screen channel in the top side of the rear end of the front top portion, the screen channels in the front and rear top portions providing ledges on which the screen can be secured.

18. The beehive according to claim 17, further comprising screen rails secured to the first and second side walls, the screen rails having a top surface that aligns with the screen channels in the front and rear top portions of the stand body to secure the screen adjacent the first and second side walls.

19. The beehive according to claim 11, wherein the litter tray of the drawer comprises a bottom portion having a flat surface with front and rear end walls and side walls extending upward from the flat surface of the bottom portion.

20. The beehive according to claim 19, wherein the flat surface of the bottom portion of the litter tray comprises grid lines thereon for visual referencing and collection of metrics related to waste that falls from chambers of the beehive.
